(19) United States
(12) Patent Application Publication
(10) Pub. No.: US 2011/0153715 A1
(43) Pub. Date: Jun. 23, 2011

(54) LIGHTWEIGHT SERVICE MIGRATION

(75) Inventors: Jacob Oshins, Seattle, WA (US); Dustin L. Green, Redmond, WA (US)

(73) Assignee: Microsoft Corporation, Redmond, WA (US)

(21) Appl. No.: 12/640,318

(22) Filed: Dec. 17, 2009

(51) Int. Cl. G06F 15/16

(52) U.S. Cl. 709/203; 709/217

(57) ABSTRACT

Techniques for migrating lightweight services in a datacenter are described. In an example embodiment the services can be attached to virtual ports of embedded switches and assigned unique network identifiers. The services can be migrated from one physical host to another by migrating the unique identifiers and associating them with instantiated instances of at least equivalent services.

### CROSS REFERENCE TO RELATED APPLICATION

This application is related by subject matter to U.S. application Ser. No. ______ (Attorney Docket Number MVIR-0581/328024.01) entitled “Virtual Storage Target Offload Techniques” filed on Dec. 17, 2009, the contents of which are herein incorporated by reference in their entirety.

### BACKGROUND

Virtual machine technology can be used to package up a workload and move it in a datacenter. This ability to move a workload from one physical host to another is a tremendous benefit for users because it allows for dynamic machine consolidation which leads to much lower hardware and administrative costs. This ability comes, however, with a relatively large cost due to the fact that most workloads must be typically surrounded by virtual machines in order to be moved. A workload that could be migrated may not “fit” on another computer because of the size of the surrounding infrastructure. One way to increase the portability of workloads is to increase the amount of physical resources available; however, this approach reduces the benefits obtained from machine consolidation. Accordingly, techniques for reducing the overhead infrastructure needed to support workloads are desirable.

### SUMMARY

An example embodiment of the present disclosure describes a method. In this example, the method includes, but is not limited to attaching a first process configured to effectuate a networked input/output service to a first embedded switch virtual port, the first embedded switch virtual port including a unique identifier in a network; and sending the unique identifier to a remote computer system configured to effectuate a second embedded switch virtual port that includes the unique identifier and attach a second process to the second embedded switch virtual port. In addition to the foregoing, other aspects are described in the claims, drawings, and text forming a part of the present disclosure.

An example embodiment of the present disclosure describes a method. In this example, the method includes, but is not limited to assigning a unique identifier for a network to a embedded switch virtual port; and attaching a process to the embedded switch virtual port, wherein the unique identifier is exclusively used by the process, wherein the process is configured to effectuate a networked input/output service for computer systems coupled to the network. In addition to the foregoing, other aspects are described in the claims, drawings, and text forming a part of the present disclosure.

An example embodiment of the present disclosure describes a method. In this example, the method includes, but is not limited to executing a first process configured to effectuate a networked input/output service, wherein the first process is attached to a first embedded switch virtual port including a unique identifier in a network; determining that availability of a hardware resource is lower than a predetermined threshold; and sending the unique identifier, state information for a protocol stack associated with the first embedded switch virtual port and state information for the first process to a remote computer system configured to effectuate a second embedded switch virtual port that includes the unique identifier and attach a second process to the second embedded switch virtual port. In addition to the foregoing, other aspects are described in the claims, drawings, and text forming a part of the present disclosure.

It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system wherein aspects of the present disclosure can be implemented.

FIG. 2 depicts an operational environment for practicing aspects of the present disclosure.

FIG. 3 depicts an operational environment for practicing aspects of the present disclosure.

FIG. 4 illustrates a computer system having a SR-IOV compliant adapter.

FIG. 5 illustrates a datacenter used to illustrate embodiments of the present disclosure.

FIG. 6 depicts operational procedure for practicing aspects of the present disclosure.

FIG. 7 depicts an alternative embodiment of the operational procedure of FIG. 6.

FIG. 8 depicts operational procedure for practicing aspects of the present disclosure.

FIG. 9 depicts an alternative embodiment of the operational procedure of FIG. 8.

FIG. 10 depicts operational procedure for practicing aspects of the present disclosure.

FIG. 11 depicts an alternative embodiment of the operational procedure of FIG. 10.

### DETAILED DESCRIPTION

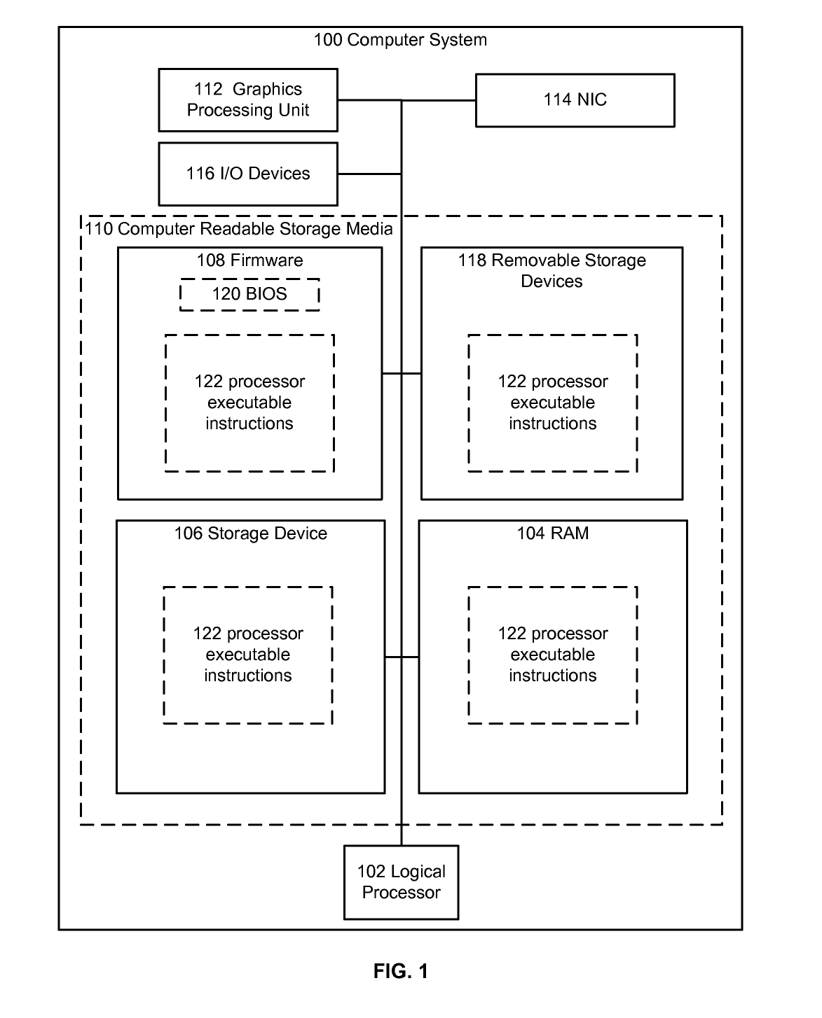

Embodiments may execute on one or more computer systems. FIG. 1 and the following discussion are intended to provide a brief general description of a suitable computing environment in which the disclosure may be implemented.

The term circuitry used throughout the disclosure can include hardware components such as hardware interrupt controllers, hard drives, network adaptors, graphics processors, hardware based video/audio codecs, and the firmware used to operate such hardware. The term circuitry can also include microprocessors, application specific integrated circuits, and/or one or more logical processors, e.g., one or more cores of a multi-core general processing unit configured by firmware and/or software. Logical processor(s) can be configured by instructions embodying logic operable to perform function(s) that are loaded from memory, e.g., RAM, ROM, firmware, and/or mass storage. In an example embodiment where circuitry includes a combination of hardware and software an implementer may write source code embodying logic that is subsequently compiled into machine readable code that can be executed by a logical processor. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary computing system 100 is depicted. Computer system 100 can include a logical processor 102, e.g., a hyperthread of an execution core. While one logical processor 102 is illustrated, in other embodiments computer system 100 may have multiple logical processors, e.g., multiple execution cores per processor substrate and/or multiple processor substrates that could each have multiple execution cores. As shown by the figure, various computer readable storage media 110 can be interconnected by one or more system busses which couples various system components to the logical processor 102. The system buses may be any of several types of bus structures including a memory bus or memory controller, a peripheral bus, and a local bus using any of a variety of bus architectures. In example embodiments the computer readable storage media 110 can include for example, random access memory (RAM) 104, storage device 106, e.g., electromechanical hard drive, solid state hard drive, etc., firmware 108, e.g., FLASH RAM or ROM, and removable storage devices 118 such as, for example, CD-ROMs, floppy disks, DVDs, FLASH drives, external storage devices, etc. It should be appreciated by those skilled in the art that other types of computer readable storage media can be used such as magnetic cassettes, flash memory cards, digital video disks, Bernoulli cartridges.

The computer readable storage media 110 can provide non volatile and volatile storage of processor executable instructions 122, data structures, program modules and other data for computer 100. A basic input/output system (BIOS) 120, containing the basic routines that help to transfer information between elements within the computer system 100 during start up can be stored in firmware 108. A number of programs may be stored on firmware 108, storage device 106, RAM 104, and/or removable storage devices 118, and executed by logical processor 102 including an operating system and/or application programs.

Commands and information may be received by computer 100 through input devices 116 which can include, but are not limited to, a keyboard and pointing device. Other input devices may include a microphone, joystick, game pad, scanner or the like. These and other input devices can be connected to the logical processor 102 through a serial port interface that is coupled to the system bus, and are often connected by other interfaces, such universal serial bus ports (USB). A display or other type of display device can also be connected to the system bus via an interface, such as a video adapter which can be part of, or connected to, a graphics processor 112. In addition to the display, computers typically include other peripheral output devices (not shown), such as speakers and printers. The exemplary system of FIG. 1 can also include a host adapter, Small Computer System Interface (SCSI) bus, and an external storage device connected to the SCSI bus.

Computer system 100 may operate in a networked environment using logical connections to remote computers. The remote computer may be another computer, a server, a router, a network PC, a peer device or other common network node, and typically can include many or all of the elements described above relative to computer system 100.

When used in a LAN or WAN networking environment, computer system 100 can be connected to the LAN or WAN through a network interface card 114. The NIC 114, which may be internal or external, can be connected to the logical processor. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

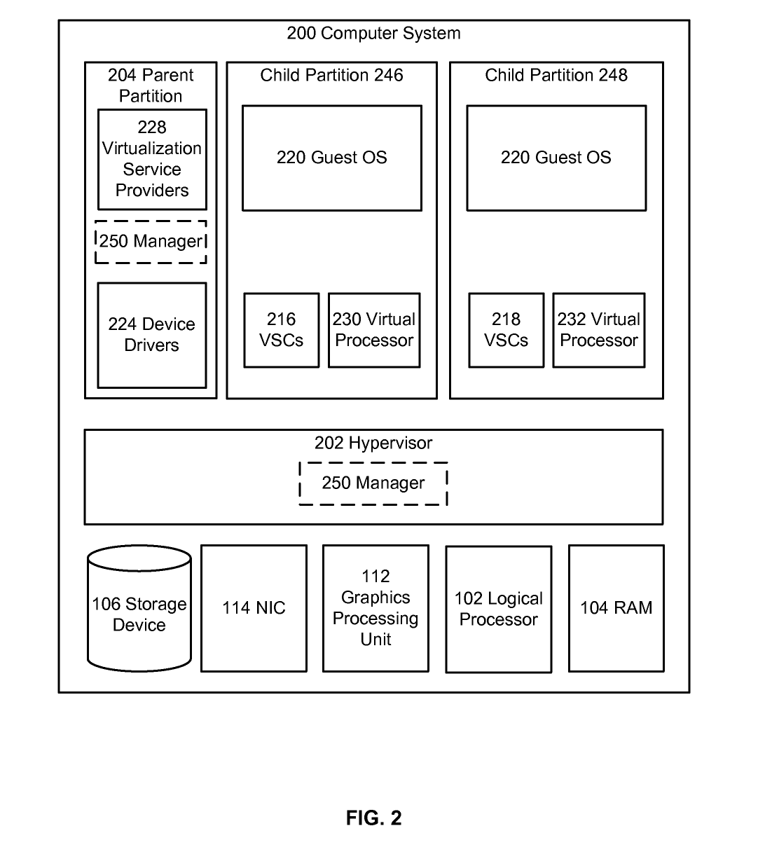

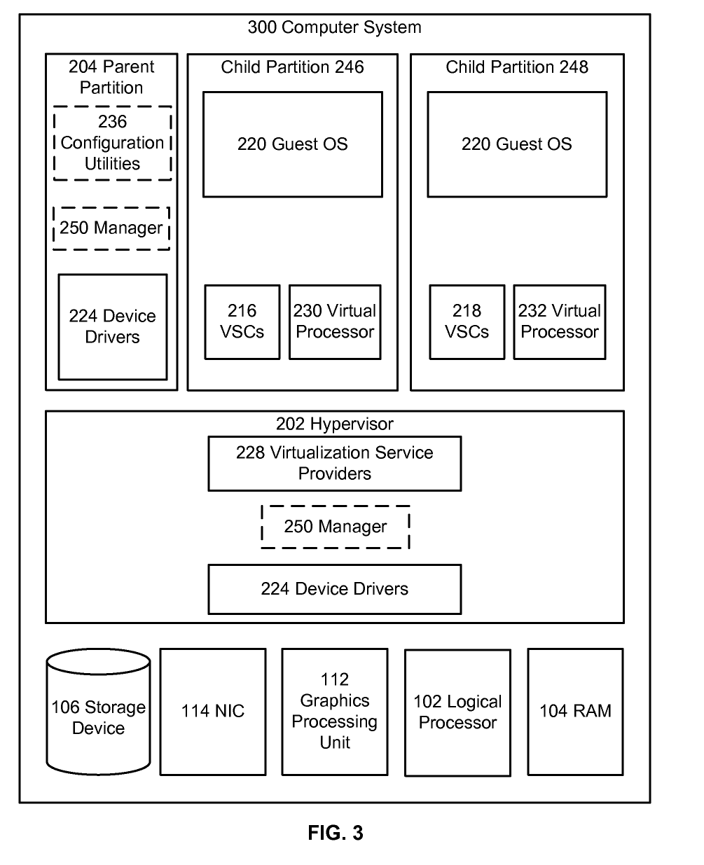

Referring now to FIGS. 2 and 3, they depict high level block diagrams of computer systems 200 and 300 configured to effectuate virtual machines. In example embodiments of the present disclosure computer systems 200 and 300 can include elements described in FIG. 1 and components operable to effectuate virtual machines. Turning to FIG. 2, one such component is a hypervisor 202 that may also be referred to in the art as a virtual machine monitor. The hypervisor 202 in the depicted embodiment can be configured to control and arbitrate access to the hardware of computer system 100. Broadly, the hypervisor 202 can generate execution environments called partitions, e.g., virtual machines. In embodiments a child partition can be considered the basic unit of isolation supported by the hypervisor 202. That is, each child partition (246 and 248) can be mapped to a set of hardware resources, e.g., memory, devices, logical processor cycles, etc., that is under control of the hypervisor 202 and/or the parent partition and hypervisor 202 can isolate processes in one partition from accessing another partition's resources, e.g., a guest operating system in one partition may be isolated from the memory of another partition. In embodiments the hypervisor 202 can be a stand-alone software product, a part of an operating system, embedded within firmware of the motherboard, specialized integrated circuits, or a combination thereof.

In the depicted example the computer system 100 includes a parent partition 204 that can be also thought of as similar to domain 0 in the Xen® open source community. Parent partition 204 can be configured to provide resources to guest operating systems executing in the child partitions by using virtualization service providers 228 (VSPs) that are typically referred to as back-end drivers in the open source community. In this example architecture the parent partition 204 can gate access to the underlying hardware. Broadly, the VSPs 228 can be used to multiplex the interfaces to the hardware resources by way of virtualization service clients (VSCs) (typically referred to as front-end drivers in the open source community). Each child partition can include one or more virtual processors such as virtual processors 230 through 232 that guest operating systems 220 through 222 can manage and schedule threads to execute thereon. Generally, the virtual processors 230 through 232 are executable instructions and associated state information that provide a representation of a physical processor with a specific architecture. For example, one child partition may have a virtual processor having characteristics of an Intel x86 processor, whereas another virtual processor may have the characteristics of a PowerPC processor. The virtual processors in this example can be mapped to logical processors of the computer system such that virtual processor execution of instructions is backed by logical processors. Thus, in these example embodiments, multiple virtual processors can be simultaneously executing while, for example, another logical processor is executing hypervisor instructions. The combination of virtual processors, various VSCs, and memory in a partition can be considered a virtual machine.

Guest operating systems 220 through 222 can include any operating system such as, for example, operating systems from Microsoft®, Apple®, the open source community, etc. The guest operating systems can include user/kernel modes of operation and can have kernels that can include schedulers, memory managers, etc. Generally speaking, kernel mode can include an execution mode in a logical processor that grants access to at least privileged processor instructions. Each guest operating system 220 through 222 can have associated file systems that can have applications stored thereon such as terminal servers, e-commerce servers, email servers, etc., and the guest operating systems themselves. The guest operating systems 220-222 can schedule threads to execute on the virtual processors 230-232 and instances of such applications can be effectuated.

Referring now to FIG. 3, it illustrates an alternative architecture to that described above in FIG. 2. FIG. 3 depicts similar components to those of FIG. 2; however in this example embodiment the hypervisor 202 can include the virtualization service providers 228 and device drivers 224, and parent partition 204 may contain configuration utilities 236. In this architecture hypervisor 202 can perform the same or similar functions as the hypervisor 202 of FIG. 2. The hypervisor 202 of FIG. 3 can be a stand alone software product, a part of an operating system, embedded within firmware of the motherboard or a portion of hypervisor 202 can be effectuated by specialized integrated circuits. In this example parent partition 204 may have instructions that can be used to configure hypervisor 202 however hardware access requests may be handled by hypervisor 202 instead of being passed to parent partition 204.

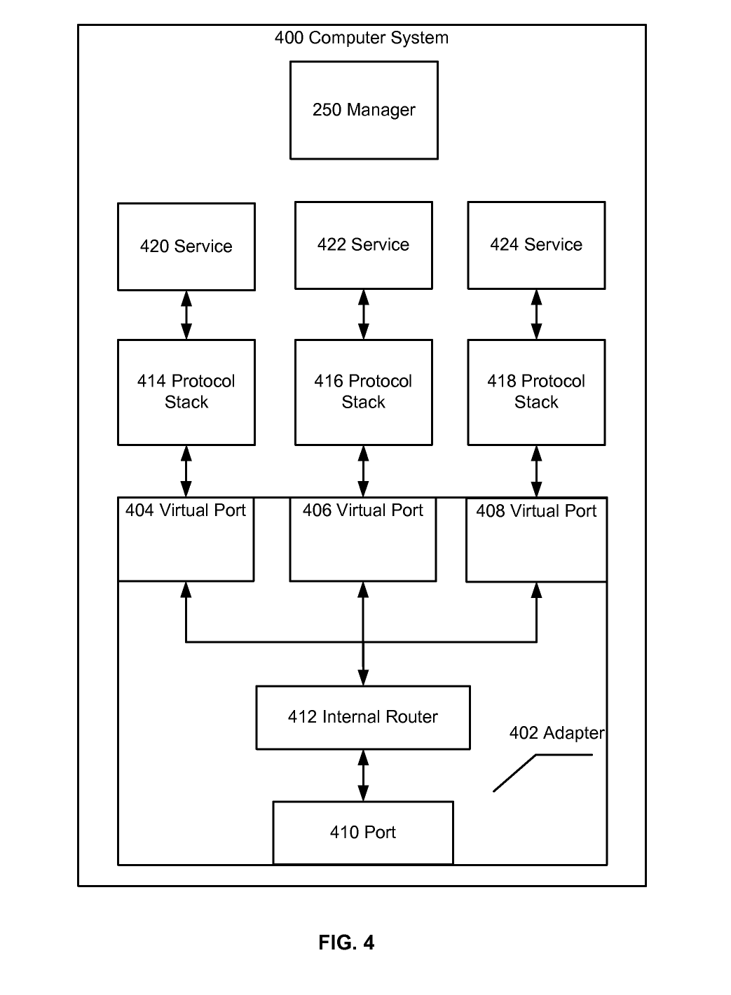

Turning to FIG. 4, it illustrates a computer system 400 including an adapter 402 having an embedded (virtual or physical) network switch. An example adapter could be the “Gigabit ET Dual Port Server Adapter” from Intel® which has an embedded physical switch. Similar to that stated above, computer system 400 can include components similar to those above with respect to FIG. 1-3. The adaptor 402 can include a physical function which can correspond to port 410. In an example Ethernet embodiment, the adapter can have a virtual embedded bridge which routes traffic between various sets of network packet queues. These queues, when grouped together, can form a virtual port on this embedded switch. The virtual ports can be coupled to the physical port 410 via an internal router 412. Internal router 412 can be configured to route data to and from network identifiers of adapter 402 such as those assigned to virtual ports 404-408 via the embedded switch.

Each virtual port can have an associated protocol stack (414-418) bound to a service. In an example embodiment services (420-424) can include key servers, email servers, web servers, terminal servers, file servers, block servers, or any other type of server that provides input/output functionality to the network. In general, the protocol stacks (414-418) are configured to format information generated by the services so that the port can send it over the network. In a specific TCP/IP example a service can bind to an instance of the TCP/IP stack's application layer through an application layer port. Eventually information that is processed by different functions of the protocol stack can be processed by a group of functions that reside in what is know as the media access control layer which is in charge of assembling frames of data that will be sent over the network. This layer of the protocol stack adds the media access control address for the virtual port to frames that are sent out on the network. The protocol stack then passes the assembled frames to the physical layer which is configured to convert the information in the frame into electrical signals.

In one example embodiment adapter 402 can conform to the “Single Root Input/Output Virtualization specification” Revision 1.0 herein expressly incorporated by reference in its entirety which can be used to more efficiently expose network traffic to virtual machines. SR-IOV capable network devices are hardware devices that can share an I/O adapter between, for example, virtual machines, or any other process by virtualizing the interface to a physical function. Each virtualized interface, also known as a virtual function (VF), roughly appears as a separate network interface card on a PCI-express bus of a computer system. For example, each virtual function can have an emulated PCI configuration space and a unique network identifier, e.g., a media access control address (MAC address), world wide name, etc. Thus, each virtual function can support a uniquely addressed and strongly partitioned separate path for accessing a physical function.

In example embodiments a network adapter can be an Ethernet adapter and the virtual port can be an emulated Ethernet adapter port. In this example the virtual port's unique identifier would be an Ethernet MAC address. In a Fibre channel example, the adapter can be a fibre channel host bus adapter and a virtual port can be a virtual fibre channel host bus adapter having a world wide name such as a world wide node name and a world wide port name. In fibre channel this ability is called N_Port ID virtualization or NPIV. In an Infiniband example, the s virtual port can emulate an Infiniband switch having a global identifier as a unique network identifier.

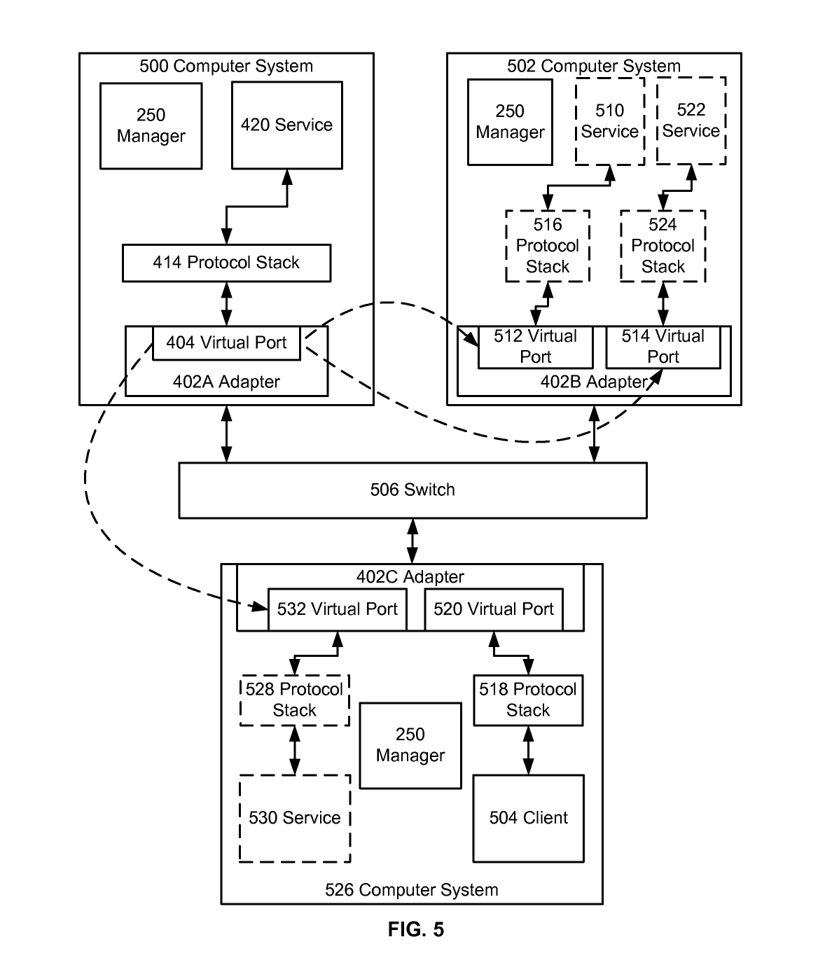

Turning to FIG. 5, it illustrates an example operational environment for practicing aspects of the present disclosure. The figure depicts an example datacenter including networked computer systems 500, 502, and 526 coupled together via a switch 506. As one of skill in the art can appreciate, computer systems 500, 502, and 526 can have components similar to those described in FIGS. 1-4 and switch 506 could be an entire infrastructure of interconnected switches and routers. Furthermore, computer system 500, 502, and 526 are is illustrated as including different features to more clearly explain the herein disclosed techniques and the disclosure is not limited to the depicted topology.

Computer system 500 can include a manager 250 that is explained in more detail in the following paragraphs, a service 420 bound to a protocol stack 414 and interfacing with virtual port 404 of an embedded switch of adapter 402A. Computer system 502 is shown as including multiple services bound to multiple virtual ports (512 and 514) via multiple instances of protocol stacks (516 and 524). In this example virtual ports 512 and 514 could be exclusively used by services 510 and 522. FIG. 5 also shows a computer system 526 including client 504 and service 530. In this example the client can be any process that relies on I/O support from a service. In an example embodiment services 420, 510, 522, and 530 can provide essentially the same service, the same service, or different services. As one skilled in the art can appreciate services 420, 510, 522, and 530 can provide the same service but be effectuated by different combinations of circuitry. The services themselves may be effectuated by the same type of hardware and software, they could be effectuated by different hardware and the same type of software, or they could be effectuated by the same type of hardware and different software.

In an embodiment of the present disclosure adapter 402 can be used to migrate a workload, e.g., an executing service, around a datacenter without having to contain the workload in a virtual machine. For example, a service such as service 420 can be instantiated on a computer system 500 and moved to other computer systems such as computer system 502 or computer system 526 by attaching the service 420 to a virtual port and migrating a unique identifier (as illustrated by the dashed arrows) used by the virtual port around the datacenter. As illustrated by the figure, service 420 can be migrated to a computer system running other services (computer system 502) or it can be migrated to a computer system that runs the client of the service (computer system 526). In the instance that a unique identifier is migrated, the new virtual port effectively becomes the old virtual port from the perspective of switch 506. In this example switch 506 could update its routing tables to send packets addressed to the unique identifier to new virtual port instead of the old one.

The following are a series of flowcharts depicting operational procedures. For ease of understanding, the flowcharts are organized such that the initial flowcharts present implementations via an overall “big picture” viewpoint and subsequent flowcharts provide further additions and/or details. Furthermore, one of skill in the art can appreciate that the operational procedure depicted by dashed lines are considered optional.

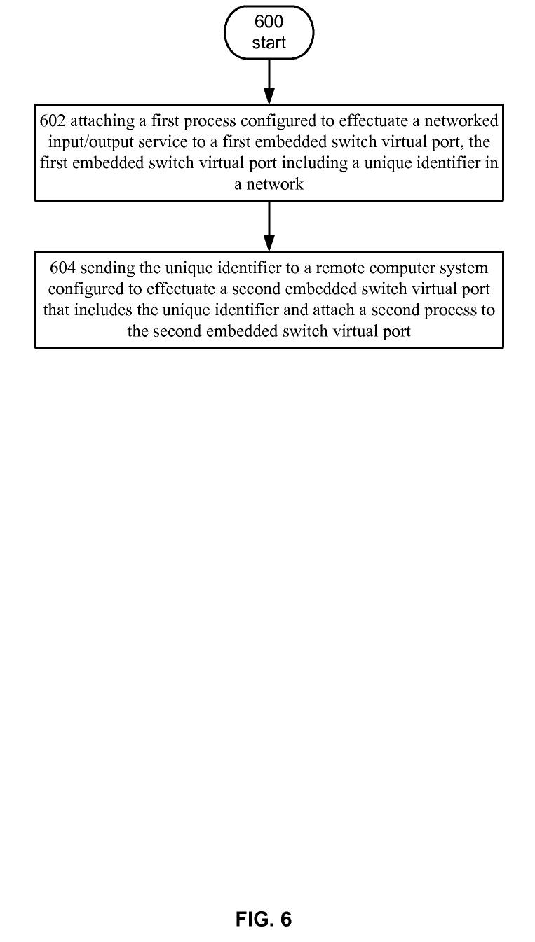

Referring now to FIG. 6, it illustrates an operational procedure for practicing aspects of the present disclosure. As shown by the figure, operation 600 begins the operational procedure and operation 602 shows attaching a first process configured to effectuate a networked input/output service to a first embedded switch virtual port, the first embedded switch virtual port including a unique identifier in a network. Turning to FIG. 5, a workload, e.g., a service such as service 420, can be effectuated by a process executing on a computer system 500 that can include components similar to those described in FIGS. 1-4. In this example service 420 can be attached to a virtual port such as virtual port 404. For example, service 420 could bind to a protocol stack that is associated with virtual port 404. Virtual port 404 can include a unique identifier that uniquely identifies its address in a datacenter. Thus, service 420 can communicate with other computer systems via switch 506 by receiving packets addressed to its unique identifier and sending packets to other computer system's unique identifiers.

After the service 420 binds itself to the unique identifier the service 420 can start to handle I/O requests. In this example client process 504 can generate an I/O request, e.g., a request to access a hard drive. In this example client 504 can be configured to send I/O requests to the unique identifier associated with the service 420 and switch 506 can receive the requests and determine where to route the requests based on the location of the unique identifier in the network.

In a specific example the adapter 402A can be a fibre channel host bus adapter and it can instantiate a virtual port that emulates a host bus adapter and the virtual port will be listed in the PCI-express space as a host bus adapter. In this example embodiment a process such as an network or virtualization infrastructure, a dynamic host configuration protocol server, a domain name system server, etc., can be attached to the virtual host bus adapter (via a protocol stack).

Depending on the implementation the service can be executing within an operating system or a guest operating system that itself is executing in a virtual machine of FIG. 2 or FIG. 3. In the example embodiment where the service is executing within a virtual machine, the virtual port may be attached to the virtual machine. From the perspective of the guest OS the virtual port will appear as an adapter coupled to a motherboard. In this example embodiment the service could be migrated if it can serialize its own state.

Continuing with the description of FIG. 6, operation 604 shows sending the unique identifier to a remote computer system configured to effectuate a second embedded switch virtual port that includes the unique identifier and attach a second process to the second embedded switch virtual port. For example, and continuing with the description of FIG. 6, computer system 500 can send the unique identifier to a computer system such as computer system 502. Computer system 502 in this example can be configured to effectuate a networked input/output service that is at least equivalent to the networked input/output service effectuated by service 420. In a specific example embodiment service 420 could be a web server. In this example, the unique identifier can be sent to a remote computer system that can execute an equivalent web server, e.g., the web server may be effectuated by the same or a similar program used to effectuate service 420.

In an example embodiment manger 250 of computer system 500 can migrate service 420 in response to receiving a signal from a system administrator via a user interface. In this embodiment manager 250 can interface with adaptor 402A and request the unique identifier associated with service 420. Manager 250 can then send one or more packets indicative of the unique identifier via the adaptor 402A to computer system 502.

Computer system 502 in this example can also include manger 250, e.g., executable instructions, that can be executed on a logical processor and receive the unique identifier, e.g., by accessing RAM that stored the unique identifier. Manager 250 can run and request that adapter 402B instantiate virtual port 512. Manger 250 can then access an interface of adapter 402B and instruct it to assign the newly spawned virtual port 512 the unique identifier previously assigned to virtual port 404. Manager 250 can then run instructions that setup protocol stack 516 that binds to service 510.

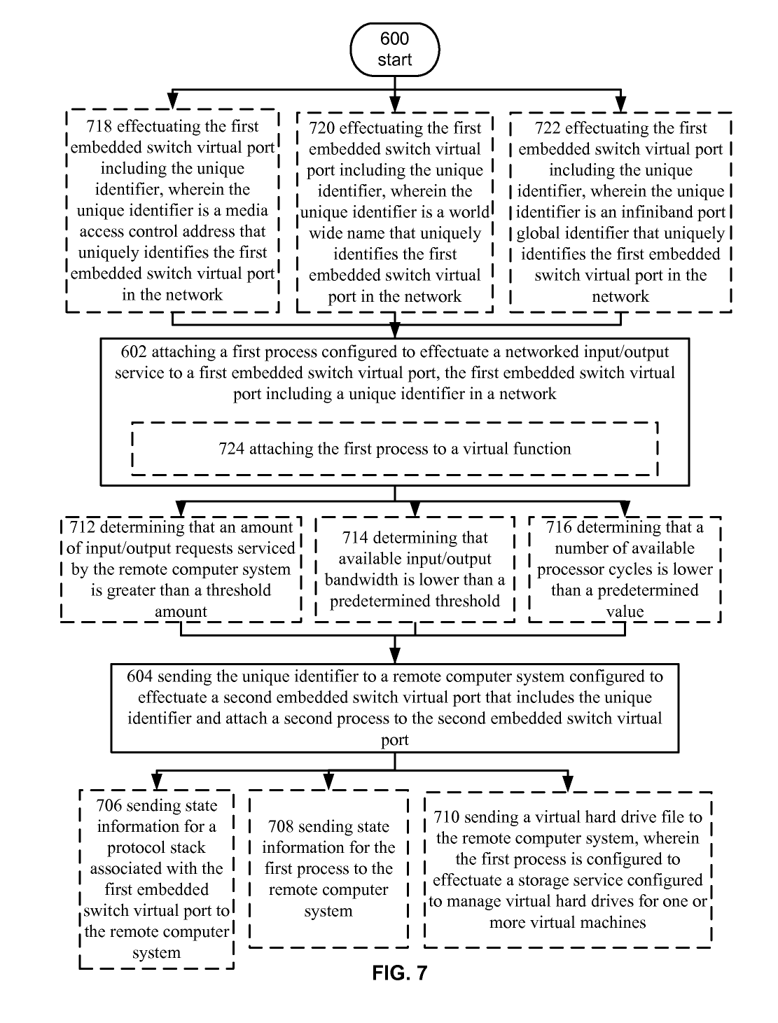

Turning now to FIG. 7, it illustrates an alternative embodiment of the operational procedure of FIG. 6 including operations 706-724. Operation 706 shows sending state information for a protocol stack associated with the first embedded switch virtual port to the remote computer system. For example, and turning to FIG. 5, state information for protocol stack 414 of computer system 500 can be sent to computer system 502. In this example manager 250 of computer system 500 can be executed and obtain state information for protocol stack 414 and send it via one or more packets of information to computer system 502 via the adapter 402.

In an example embodiment state information can include enough information to allow manager 250 of computer system 502 to configure protocol stack 516 to reflect at least a functionally equivalent state of protocol stack 414 from the point of view of the rest of the network. State information can include enough information so that a protocol stack can be instantiated and setup to have an open connection that is functionally the same as a connection service 420 had with a client 504.

In a specific Ethernet example state information could include the number of the next packet that is going to be sent to the TCP/IP connection, the socket number that is used, the maximum buffer size, the server's port number, the client's port number, etc. State information can also include information such as higher level protocol information. For example, a remote desktop protocol has state information that reflects the color mode set for the session, whether certain plug-n-play devices are remotable, whether certain video codecs are present. Other examples could be information used by encryption protocols.

In this example embodiment service to the clients would operate uninterrupted because from the point of view of the client the connection was paused instead of dropped. For example, when service 420 is migrated protocol stack 414 can wrap-up the current operations it is performing, e.g., by completing or canceling them, and send a back off message to protocol stack 518 requesting that it hold from sending information for a short period of time. When protocol stack 516 is instantiated it can have an equivalent state as protocol stack 414. It can send a logon message to the network with the unique identifier that was previously used by virtual port 404 and protocol stack 518 can resume sending information.

Continuing with the description of FIG. 7, operation 708 illustrates sending state information for the first process to the remote computer system. For example, and referring again to FIG. 5, state information for service 420, e.g., variables and data that reflect a unique configuration, can be sent to service 510 and service 510 can be configured to have the same state as service 420 when it was migrated. In an embodiment service 420 can be written so that it can serialize its state when it receives a signal from manager 250 and the serialized state can be sent in one or more packets of information to manager 250 of computer system 502. Manager 250 can provide the serialized state information to service 510 which can unpack the information and configure it accordingly.

Continuing with the description of FIG. 7, operation 710 shows sending a virtual hard drive file to the remote computer system, wherein the first process is configured to effectuate a storage service configured to manage virtual hard drives for one or more virtual machines. For example information that represents a virtual hard drive file (VHD file) can be stored in storage and the file can be sent to the remote computer system. In one example embodiment the storage service can be exposed as a storage target similar to that described in U.S. application Ser. No. ______ (Attorney Docket Number MVIR-0581/328024.01) entitled “Virtual Storage Target Offload Techniques.” A VHD file is a virtual machine hard disk and associated metadata that can be encapsulated within a single file in physical storage. In an example embodiment a process running on a computer system that effectuates the virtual machine, e.g., a virtual machine storage service, can parse the file and effectuate a disk that can be exposed to a guest operating system as physical storage. In this example embodiment the remote computer system 502 can receive the VHD file after service 420 is migrated. For example, the VHD file can be sent before service 420 is migrated by tagging the data in the file as copy-on-write. In this instance the data can be copied over when it is needed by service 420. In another example the VHD file can be copied before service 420 is migrated.

Continuing with the description of FIG. 7, operation 712 shows determining that an amount of input/output requests serviced by the remote computer system is greater than a threshold amount. For example, and turning back to FIG. 5, in an example embodiment manager 250 can be executed by a logical processor and determine that computer system 502 is servicing more requests than a threshold amount by, for example, comparing the number of requests it services to a value stored in memory, calculating the ratio of requests computer system 502 services to those serviced by computer system 500 and comparing the ratio to a threshold ratio, or by using any other statistical measure to determine whether a threshold is met. In this example if the number of requests serviced is greater than the threshold amount stored in memory manager 250 can be configured to move the unique identifier and service 420 to a virtual port associated with computer system 502.

In a specific embodiment the service can be distributed and computer system 500 can act as the interface for the service, e.g., service 420 and service 510 can be one distributed service and service 420 may be the point of interaction. In this example requests received by service 420 may be forwarded to service 510 for processing. In an example embodiment where an amount of requests over a threshold amount are forwarded to computer system 502 manager 250 of either computer system migrate service 420 so that service 420 and 510 are co-located on the same computer system 502. In this specific example the unique identifier for virtual port 404 could be attached to virtual port 514. Thus, when service 522 forwards a request to service 510 for processing its request can be routed internally within adapter 402B instead of going out into the switch 506 reducing the bandwidth used in the switch. In this example the request may be serviced faster because it won't have to be sent to another computer system. In another specific example embodiment, once service 522 is executing on computer system 502 and it receives a request for I/O that would have been previously sent to service 510, it can simply service the I/O request itself since it has access to the resources of computer system 502. In this case service 510 can be shut down if no other computer systems in the network are using it. The selection of either of these options is based on how the service itself is built.

Continuing with the description of FIG. 7, operation 714 shows determining that available input/output bandwidth is lower than a predetermined threshold. For example, in an embodiment manager 250 can migrate the unique identifier when I/O bandwidth is lower than a predetermined threshold. In an example embodiment I/O bandwidth of computer system 500 may be stressed when too many I/O requests are being processed. In this example when the available bandwidth is lower than a value manger 250 of computer system 500 can send a request out to the network for a computer system that has bandwidth available. In a basic example the value can be set by an administrator. In another example the value can be set in view of a ratio including one or more variables. A specific example may include determining the bandwidth of each computer system in the datacenter and migrating the service to a computer system that has over 30% more bandwidth. Another specific example threshold may be based on the average time an I/O will take to be completed on computer system 500 in view of the current bandwidth and the average time an I/O will take to be completed on other computer systems in the datacenter based on their available bandwidth. As one skilled in the art can appreciate, the threshold value can depend on what type of equipment is in the datacenter or how “mission critical” a particular service is. Thus, one skilled in the art can understand that a bandwidth threshold can be set based on the needs and equipment in their datacenter and the disclosure contemplates using any metric used to set a bandwidth threshold.

Continuing with the description of FIG. 7, operation 716 shows determining that a number of available processor cycles is lower than a predetermined value. For example, in an embodiment of the present disclosure manager 250 can migrate the unique identifier when available processor cycles are lower than a predetermined threshold. In an example embodiment processor cycles of a computer system can be stressed when too many processes, e.g., hypervisor, service 420, protocol stacks, etc, are being executed by the physical processors of the computer system. In this example when the available processor cycles are lower than a value manger 250 of computer system 500 can send a request out to the network for a computer system that has free processor cycles. As one skilled in the art can appreciate, the threshold value can depend on what type of equipment is in the datacenter and how “mission critical” the service is. Thus, one skilled in the art can understand that a processor cycles threshold can be set based on the needs and equipment in their datacenter and the disclosure contemplates using any metric used to set a processor cycle threshold.

Continuing with the description of FIG. 7, operation 718 shows effectuating the first embedded switch virtual port including the unique identifier, wherein the unique identifier is a media access control address that uniquely identifies the first embedded switch virtual port in the network. For example, in an embodiment the unique identifier can be a media access control address (MAC address). In this example if manager 250 migrates a service the MAC address of the virtual port can be sent to the remote computer system 502. In this example the MAC address uniquely identifies the address of virtual port 404 on the network and is used in a media access control protocol sub-layer of a protocol stack. Switch 506 can keep a list of the MAC addresses in the datacenter and when packets of information associated with the MAC address are received from computer system 502 then the switch 506 can update its routing table to reflect that the MAC address moved. From the viewpoint of the switch 506 it will be as if an Ethernet adapter was physically moved from computer system 500 to computer system 502.

Continuing with the description of FIG. 7, operation 720 shows effectuating the first embedded switch virtual port including the unique identifier, wherein the unique identifier is a world wide name that uniquely identifies the first embedded switch virtual port in the network. For example, in an embodiment the unique identifier can be a world wide name assigned to a port in a Fibre channel fabric. For example the world wide name could include a world wide port name and a world wide node name. In this example when manager 250 executes a migration operation the world wide port name used by the virtual port can be sent to the remote computer system 502.

Continuing with the description of FIG. 7, operation 722 shows effectuating the first embedded switch virtual port including the unique identifier, wherein the unique identifier is an infiniband port global identifier that uniquely identifies the first embedded switch virtual port in the network. For example, in an embodiment the unique identifier can be a global identifier assigned to a port in an infiniband network. In this example if manager 250 executes a migration operation the global identifier used by the virtual port 404 can be sent to the remote computer system 502.

Continuing with the description of FIG. 7, operation 724 shows attaching the first process to a virtual function. For example, and turning to FIG. 5, in this example embodiment adapter 402A can be a SR-IOV compliant adapter and service 420 can be bound to a virtual function and the virtual function can include a unique identifier that uniquely identifies its address in a datacenter. Thus, service 420 can communicate with other computer systems via switch 506 by receiving packets addressed to its unique identifier and sending packets to other computer system's unique identifiers itself to the unique identifier the service 420 can start to handle I/O requests. In this example client process 504 can generate an I/O request, e.g., a request to access a hard drive. In this example client 504 can be configured to send I/O requests to the unique identifier associated with the service 420 and switch 506 can receive the requests and determine where to route the requests based on the location of the unique identifier in the network.

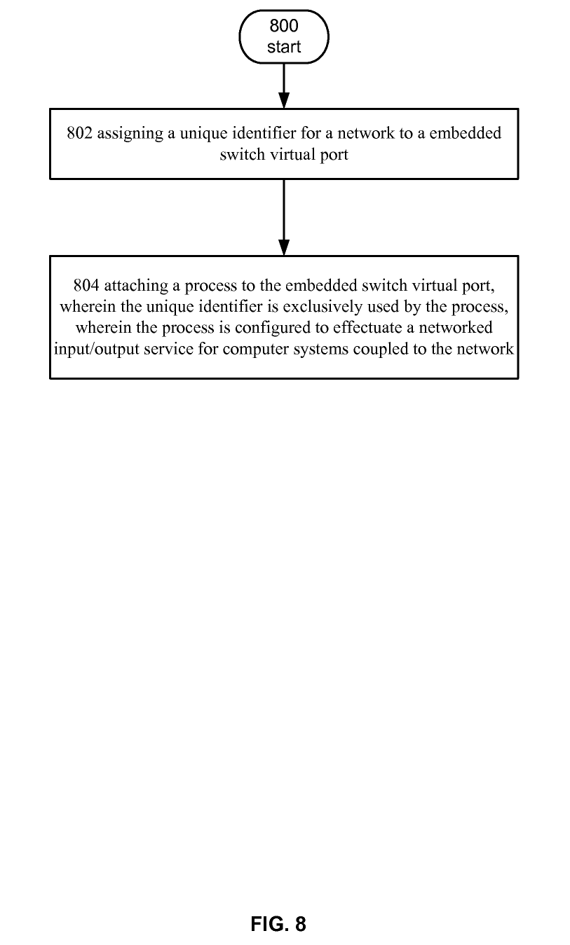

Turning to FIG. 8, it illustrates an operational procedure including operations 800, 802, and 804. Operation 800 begins the operational procedure and operation 802 shows assigning a unique identifier for a network to a embedded switch virtual port. Turning to FIG. 5, adaptor 402B can be configured to setup a virtual port to include a unique identifier for a network. For example, adaptor 402B can have an interface that can be accessed and configured to effectuate virtual port 512 having a unique identifier that uniquely identifies an address in a datacenter, e.g., a fibre channel world wide name. In this example manager 250 can be run by a logical processor and a can access the interface and to request that virtual port 512 is assigned the unique identifier.

Continuing with the description of FIG. 8, operation 804 shows attaching a process to the embedded switch virtual port, wherein the unique identifier is exclusively used by the process, wherein the process is configured to effectuate a networked input/output service for computer systems coupled to the network. Turning to FIG. 5, a service such as service 510 can be effectuated by a process executing on computer system 502. In this example service 510 can be attached to virtual port 512 by binding to a protocol stack 516 associated with the virtual port 512. Thus, service 510 can communicate with other computer systems via switch 506 by sending packets addressed with its unique identifier. In an embodiment of the present disclosure where a service is exclusively using a unique identifier, i.e., it is the only process communicating on the fabric with the address, the service can be easily migrated by moving the unique identifier and attaching it to at least an equivalent service.

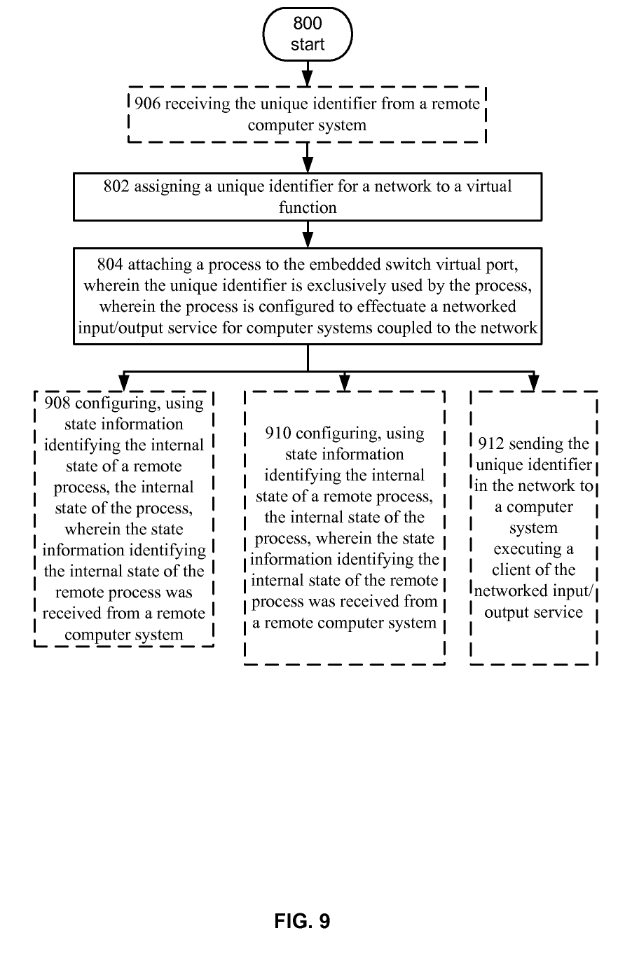

Turning now to FIG. 9, it illustrates an alternative embodiment of the operational procedure of FIG. 8 including additional operations 906 to 912. Turning to operation 906 it illustrates receiving the unique identifier from a remote computer system. For example, in an embodiment of the present disclosure the unique identifier can be received from a remote computer system such as computer system 500. In this example embodiment manager 250 of computer system 500 and/or 502 can be configured to migrate a service in response to user input. Similar to that described above, computer system 502 in this example can be configured to effectuate a networked input/output service 510 that was equivalent to the networked input/output service effectuated by service 420.

Continuing with the description of FIG. 9, operation 908 shows configuring, using state information identifying the internal state of a remote process, the internal state of the process, wherein the state information identifying the internal state of the remote process was received from a remote computer system. For example, and referring again to FIG. 5, state information, e.g., variables and data that reflect a unique configuration for service 420 could be used by service 510 to configured itself to have the same state as service 420 when it was migrated. In an embodiment service 420 can be written so that it can serialize its state when it receives a signal from manager 250 and the serialized state can be sent in one or more packets of information to manager 250 of computer system 502. Manager 250 can provide the serialized state information to service 510 which can unpack the information and configure itself accordingly.

Continuing with the description of FIG. 9, operation 910 shows configuring, using state information identifying the internal state of a remote protocol stack, a protocol stack configured to interface the process with the embedded switch virtual port, wherein the state information identifying the internal state of the remote protocol stack was received from a remote computer system. For example, and turning to FIG. 5, state information for protocol stack 414 of computer system 500 can used to configure protocol stack 516. In an example embodiment state information can include enough information to allow manager 250 of computer system 502 to configure protocol stack 516 to reflect at least a functionally equivalent state of protocol stack 414 from the point of view of the rest of the network. Put another way, state information can include enough information so that protocol stack 516 can be instantiated and setup to have an open connection that is functionally the same as a connection state of protocol stack 414.

In this example embodiment service to the clients would operate uninterrupted because from the point of view of the client the connection was paused instead of dropped. For example, when service 420 is migrated protocol stack 414 can wrap-up the current operations it is performing, e.g., by completing or canceling them, and send a back off message to protocol stack 518 requesting that it hold from sending information for a short period of time. When protocol stack 516 is instantiated it can have an equivalent state as protocol stack 414. It can send a logon message to the network with the unique identifier that was previously used by virtual port 404 and protocol stack 518 can resume sending information.

Continuing with the description of FIG. 9, operation 912 shows sending the unique identifier in the network to a computer system executing a client of the networked input/output service. For example, in an embodiment the unique identifier can be sent to a computer system that is executing client 504 of the service 420. For example, and turning to FIG. 5, computer system 526 can be sent the unique identifier. Typically I/O request will be faster if the computer system handling them is the same as the one that runs the client. Thus, in an embodiment the service (or an equivalent service) can be executed on the same computer as the client and I/O can be routed between different virtual ports of the adapter 402C thereby keeping traffic off the switch 506 and without interrupting service to the client.

In an example embodiment this technique can be used when booting computer system 526 and using remote storage. For example, the bios of computer system 526 can be configured to use a networked address to boot from during a boot process and boot from a disk controlled by service 420. The operating system can load and data can be copied over to computer system 526. When enough data is copied over manager 250 can migrate the unique identifier to computer system 526 and it can be assigned to a virtual port attached to service 530. In this example the data is then accessed locally thereby reducing the bandwidth used in switch 506 to fetch data.

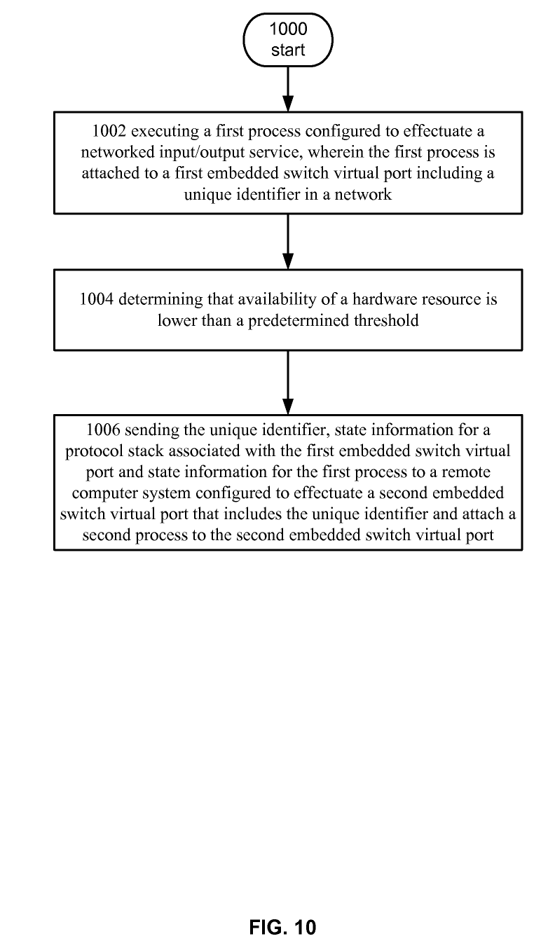

Turning now to FIG. 10, it illustrates an operational procedure for practicing aspects of the present disclosure including operations 1000, 1002, 1004, and 1006. Operation 1000 begins the operational procedure and operation 1002 shows executing a first process configured to effectuate a networked input/output service, wherein the first process is attached to a first embedded switch virtual port including a unique identifier in a network. Turning to FIG. 5, a service such as service 420 can be effectuated by a process executing on computer system 500. In this example service 420 can be attached to a virtual port such as virtual port 404 and bind to protocol stack 414. Virtual port 404 can include a unique identifier that uniquely identifies its address in a datacenter. Thus, service 420 can communicate with other computer systems via switch 506 by receiving packets addressed to its unique identifier and sending packets to other computer system's unique identifiers.

Continuing with the description of FIG. 10, operation 1004 shows determining that availability of a hardware resource is lower than a predetermined threshold. For example, and in addition to the pervious example, manager 250 can determine that the hardware resources of computer system 500 are stressed. Or put another way, the ability to service I/O requests has been reduced based on a lack of one or more hardware resources, e.g., RAM, in the computer system 500.

Turning to operation 1006, it illustrates sending the unique identifier, state information for a protocol stack associated with the first embedded switch virtual port and state information for the first process to a remote computer system configured to effectuate a second embedded switch virtual port that includes the unique identifier and attach a second process to the second embedded switch virtual port. For example, computer system 500 can send the unique identifier, state information for protocol stack 414 associated with virtual port 404, and state information for service 420 to remote computer system such as computer system 502 or computer system 526. Computer systems 502 and 526 in this example can include adapters 402B and 402C that can be configured to set a virtual port to have the unique identifier received from computer system 500. In this example computer system 502 or 526 can effectuate a second process that provides a service that is equivalent to the networked input/output service effectuated by service 420. In this example the state information for service 420 can be used to configure the second service. Similar to that described above, state information for protocol stack 414 can be used to configure protocol stack 516 or 528.

In an example embodiment manger 250 of computer system 500 migrate the unique identifier, protocol state information, and service state information in response to receiving a signal from a system administrator via a user interface. In this embodiment manager 250 can interface with adaptor 402A and request the unique identifier associated with service 420 and protocol state information. Manager 420 can also send a signal to service 420 requesting that it obtain a snapshot of its state and shut down. Manager 250 can then send one or more packets indicative of the unique identifier, the protocol state information, and the service state information via the adaptor 402A.

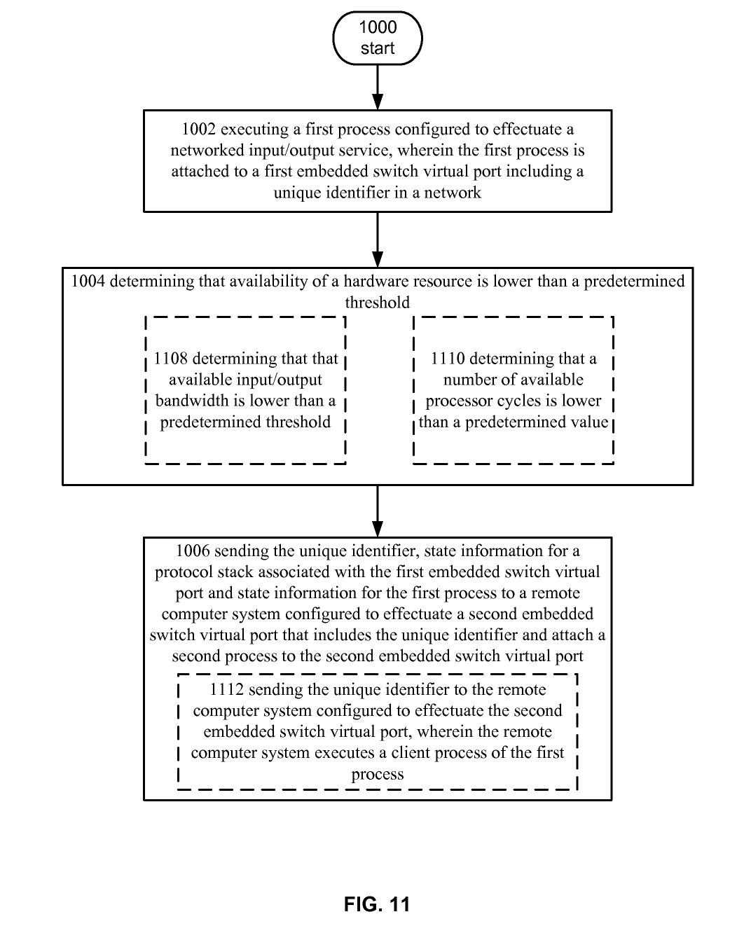

Turning to FIG. 11, it illustrates an alternative embodiment of the operational procedure of FIG. 10 including the additional operations 1108, 1110, and 1112. Operation 1108 shows determining that that available input/output bandwidth is lower than a predetermined threshold. For example, in an embodiment manager 250 can migrate the unique identifier when I/O bandwidth is lower than a predetermined threshold. In an example embodiment I/O bandwidth of computer system 500 may be stressed when too many I/O requests are being processed. In this example when the available bandwidth is lower than a value manger 250 of computer system 500 can send a request out to the network for a computer system that has bandwidth available.

Continuing with the description of FIG. 11, operation 1110 shows determining that a number of available processor cycles is lower than a predetermined value. For example, in an embodiment of the present disclosure manager 250 can migrate the unique identifier when available processor cycles are lower than a predetermined threshold. In an example embodiment processor cycles of a computer system can be stressed when too many processes, e.g., hypervisor, service 420, protocol stacks, etc, are being executed by the physical processors of the computer system. In this example when the available processor cycles are lower than a value manger 250 of computer system 500 can send a request out to the network for a computer system that has free processor cycles.

Continuing with the description of FIG. 11, operation 1112 shows sending the unique identifier to the remote computer system configured to effectuate the second embedded switch virtual port, wherein the remote computer system executes a client process of the first process. For example, in an embodiment the unique identifier can be sent to a computer system that is executing client 504 of the service 420. For example, and turning to FIG. 5, computer system 526 can be sent the unique identifier. Typically I/O request will be faster if the computer system handling them is the same as the one that runs the client. Thus, in an embodiment the service (or an equivalent service) can be executed on the same computer as the client thereby reducing traffic on switch 506. For example, when the client 504 sends a request to the unique identifier (now moved to virtual port 532) the adapter 402C can determine that the target is virtual port 532 and send the request back up through protocol stack 528 to service 530.

In an example embodiment this technique can be used when booting computer system 526 and using remote storage. For example, the bios of computer system 526 can be configured to use a networked address to boot from during a boot process and boot from a disk controlled by service 420. The operating system can load and data can be copied over to computer system 526. When enough data is copied over manager 250 can migrate the unique identifier over to computer system 526 and attach it to service 530 that can access the copied data. In this example the data is then accessed locally thereby reducing the bandwidth used in switch 506 to fetch data.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computer system, comprising:
circuitry for attaching a first process configured to effectuate a networked input/output service to a first embedded switch virtual port, the first embedded switch virtual port including a unique identifier in a network; and
circuitry for sending the unique identifier to a remote computer system configured to effectuate a second embedded switch virtual port that includes the unique identifier and attach a second process to the second embedded switch virtual port.

2. The computer system of claim 1, further comprising:
circuitry for sending state information for a protocol stack associated with the first embedded switch virtual port to the remote computer system.

3. The computer system of claim 1, further comprising:
circuitry for sending state information for the first process to the remote computer system.

4. The computer system of claim 1, further comprising:
circuitry for sending a virtual hard drive file to the remote computer system, wherein the first process is configured to effectuate a storage service configured to manage virtual hard drives for one or more virtual machines.

5. The computer system of claim 1, further comprising:
circuitry for determining that an amount of input/output requests serviced by the remote computer system is greater than a threshold amount.

6. The computer system of claim 1, further comprising:
circuitry for determining that available input/output bandwidth is lower than a predetermined threshold.

7. The computer system of claim 1, further comprising:
circuitry for determining that a number of available processor cycles is lower than a predetermined value.

8. The computer system of claim 1, further comprising:
circuitry for effectuating the first embedded switch virtual port including the unique identifier, wherein the unique identifier is a media access control address that uniquely identifies the first embedded switch virtual port in the network.

9. The computer system of claim 1, further comprising:
circuitry for effectuating the first embedded switch virtual port including the unique identifier, wherein the unique identifier is a world wide name that uniquely identifies the first embedded switch virtual port in the network.

10. The computer system of claim 1, further comprising:
circuitry for effectuating the first embedded switch virtual port including the unique identifier, wherein the unique identifier is an infiniband port global identifier that uniquely identifies the first embedded switch virtual port in the network.

11. The computer system of claim 1, wherein the circuitry for attaching the first process to the first embedded switch virtual port further comprises:
circuitry for attaching the first process to a virtual function.

12. A method, comprising:
assigning a unique identifier for a network to a embedded switch virtual port; and
attaching a process to the embedded switch virtual port, wherein the unique identifier is exclusively used by the process, wherein the process is configured to effectuate a networked input/output service for computer systems coupled to the network.

13. The method of claim 12, further comprising:
receiving the unique identifier from a remote computer system.

14. The method of claim 12, further comprising:
configuring, using state information identifying the internal state of a remote process, the internal state of the process, wherein the state information identifying the internal state of the remote process was received from a remote computer system.

15. The method of claim 12, further comprising:
configuring, using state information identifying the internal state of a remote protocol stack, a protocol stack configured to interface the process with the embedded switch virtual port, wherein the state information identifying the internal state of the remote protocol stack was received from a remote computer system.

16. The method of claim 12, further comprising:
sending the unique identifier in the network to a computer system executing a client of the networked input/output service.

17. A computer readable storage medium including computer executable instructions, the computer readable storage medium comprising:
instructions for executing a first process configured to effectuate a networked input/output service, wherein the first process is attached to a first embedded switch virtual port including a unique identifier in a network;
instructions for determining that availability of a hardware resource is lower than a predetermined threshold; and
instructions for sending the unique identifier, state information for a protocol stack associated with the first embedded switch virtual port and state information for the first process to a remote computer system configured to effectuate a second embedded switch virtual port that includes the unique identifier and attach a second process to the second embedded switch virtual port.

18. The computer readable storage medium of claim 17, wherein the instructions for determining that availability of a hardware resource is lower than a predetermined threshold further comprise:
instructions for determining that that available input/output bandwidth is lower than a predetermined threshold.

19. The computer readable storage medium of claim 17, wherein the instructions for determining that availability of a hardware resource is lower than a predetermined threshold further comprise:
instructions for determining that a number of available processor cycles is lower than a predetermined value.

20. The computer readable storage medium of claim 17, wherein the instructions for sending the unique identifier to the remote computer system configured to effectuate the second embedded switch virtual port further comprise:
instructions for sending the unique identifier to the remote computer system configured to effectuate the second embedded switch virtual port, wherein the remote computer system executes a client process of the first process.
